(19) United States
(12) Patent Application Publication
(10) Pub. No.: US 2019/0087700 A1
(43) Pub. Date: Mar. 21, 2019

(54) BIDIRECTIONAL TRANSPONDER WITH LOW ENERGY USE

(71) Applicant: Gerd REIME, Bühl (DE)

(72) Inventor: Gerd REIME, Bühl (DE)

(21) Appl. No.: 16/080,349

(22) PCT Filed: Feb. 22, 2017
(86) PCT No.: PCT/EP2017/054022

§ 371 Date: Aug. 28, 2018

(30) Foreign Application Priority Data
Feb. 29, 2016 (DE) 10 2016 103 583.1
Oct. 27, 2016 (DE) 10 2016 120 609.1

(51) Int. Cl. G06K 19/07; G06K 19/077

(52) U.S. Cl. CPC G06K 19/0702; G06K 19/0723; G06K 19/07749; G06K 19/0712

(57) ABSTRACT

The invention relates to a transponder (4.1) which has at least one wake-up unit and at least one data exchange unit for a bidirectional data communication with at least one reading device (4.5), in particular for detecting and/or controlling access authorization to rooms or objects, wherein the reading device automatically transmits signals at least during particular time periods. Because the wake-up unit is permanently ready to receive signals (4.11) for starting data communication between the transponder and the reading device, a device is provided in which a transponder can react to requests of a reading unit without a substantial loss of time in a permanent manner, i.e. not just in short time interval specified by the transponder, and thereby achieves a long service life.

### CROSS REFERENCE TO RELATED APPLICATIONS

The present application relates to and claims the priority of the German patent applications 10 2016 103 583.1, filed on 29 Feb. 2016, and 10 2016 120 609.1, filed on 27 Oct. 2016, the disclosure of both of which is hereby expressly incorporated by reference into the subject matter of the present application.

### TECHNICAL FIELD

The invention relates to a transponder, an arrangement and a method for the establishment of a bidirectional communication according to the preamble of claims 1, 12 and 13.

### BACKGROUND

RFID systems have long been used for the contactless identification of objects. The communication between the reading device and the transponder takes place by means of alternating electromagnetic fields generated by the reading device or radio waves. Passive transponders draw the required operating energy from the electromagnetic field of the reading device. Their range is therefore correspondingly restricted. For greater ranges, battery-powered transponders are also used. The transponder is then not dependent solely on the energy radiated by the reading station in order to generate its own transmitting energy.

Optical systems form a further variant of a transponder system in which the communication between the reading device and the transponder takes place on an optical basis. Also as with RFID systems, a battery support or solar energy support are used for greater ranges. In principle, such optical systems (hereinafter called “opto-ID”) function similarly to the known RFID, although they show significant differences in the information transfer. Optically, the transferred information can be transmitted in a targeted manner and also received in a targeted manner. Provided a “line-of-sight connection” exists between the reading device and the transponder, a disruption due to metal surroundings or other environmental influences (e.g. moisture, electromagnetic fields, radio disruption) are precluded. An opto-ID transponder can thus be accommodated, for example in the case of a tool or of a container, in a blind hole in solid metal and still ensure ranges of several metres without difficulty. A further advantage of an optical ID system is the security against unauthorised reading or person tracking. In contrast to classic RFID, for example, an optical transponder cannot be read unnoticed “in a trouser pocket”.

From EP 2 332 269 B1, a method for an optical transponder is known. This principle is shown in FIG. 4. Herein, an optical transponder 4.1 transmits with an optical transmitter 4.3 (light-emitting diode) at regular intervals, for example every 300 ms, a short optical identification 4.2 in the form of, for example, four bits each of 30 ns pulse length. Thereafter, the transponder 4.1 switches for a short time, for example 5 μs, into the receiving mode. If a reading device 4.5 is in the vicinity and receives the optical identification 4.2, then it in turn transmits optical signals 4.10 which are received by the transponder 4.1 during the time it is in the receiving mode. Once the reading device and the transponder have recognized one another, they can then exchange, for example, security codes which permit, for example, the reading device 4.5 to request information from the transponder 4.1 or to write information onto the transponder.

There are fundamentally two possibilities for realising an optical transponder.

First Possibility:

The transponder 4.1 in FIG. 4 emits signals 4.2 with a preferably optical transmitter 4.3 (light-emitting diode) or a radio transmitter at pre-determined time intervals (e.g. 300 ms), for example, an optical identification, and thereafter switches a receiver (photodiode) 4.4 for e.g. optical signals on for a short time (a few microseconds). (Naturally, a transponder can also send only, in which case it is a beacon). The reading device 4.5 for the preferably optical transponder is supplied by the current supply network 4.7, so that sufficient energy is always provided for the transmitter 4.9 and the receiver 4.6. Herein, the receiver 4.6 of the reading device 4.5 for the transponder 4.1 is advantageously permanently switched on and waits for signals 4.2 of a transponder. If these reach it, the (encrypted) data traffic 4.8 can begin with a back-end system (not described in detail herein). For bidirectional data exchange, the reading device itself transmits optical data 4.10 or radio data to the transponder 4.1 which receives and processes it in pre-defined time windows. This corresponds substantially to the method according to the patent EP 2 332 269 B1. Through the regular transmission of an identification, energy is utilised. Even if, in accordance with the aforementioned patent, this energy is very low during the time in which a transponder is not in the vicinity of a reading device, this is wasted energy.

Second Possibility:

The inventive step is deployed here:

According to FIG. 4a, the transponder 4.1 continuously attempts to receive a signal 4.11 of a reading unit 4.5. The transmitter 4.3 of the transponder 4.1 remains off provided no corresponding signal 4.11 is acquired. The reading unit 4.5 transmits a signal 4.11, for example, an identification with at least 1 bit, for example, 20,000 times per second. This at least one bit can be, for example, a single pulse with a length of a few microseconds. If the receiving unit 4.4 of the transponder acquires the signal 4.11, the (encrypted) data traffic 4.2 and 4.10 can begin, for example, 200 ns after the acquired identification. (FIG. 4b) Advantage: the transponder can also be used for very fast-moving goods. It does not transmit and does not “disrupt” other systems when it is not addressed by a reading unit. It uses significantly less current, provided corresponding circuit measures are taken into account. If herein optical signals are used which are also directional, disruptions cannot occur with other data paths.

In the first of the two possibilities, on optical transfer, the photodiode can be brought into the receiving mode only for a short moment (a few microseconds). For this purpose, the current for generating the blocked state can be drawn from the battery. Thus, in a circuit variant, the photodiode can also be used as a generator during the time that it is not receiving. During illumination, a voltage at the level of the saturation voltage of approximately 0.4 V arises as the generator voltage that is temporarily stored in a capacitor. The voltage of the capacitor is fed inverted to the photodiode shortly before the actual measurement and thereby places it in the blocked state. During the actual data reception, the further blocking process is maintained by the battery voltage. In practice, it has been found that for transmission and receiving 3 to 5 times per second, each time with 30-50 bits, a supply current to the whole transponder of 2-4 μA (3 V) is sufficient.

A disadvantage herein is that the “system clock cycle”, that is, the period in which the transponder transmits and shortly thereafter receives, is determined by the transponder. In the aforementioned case, therefore, every 300 ms. This is not problematic for container tracking or similar uses, since herein there is sufficient time available. The situation is different in production line operation. Herein, there are often only a few milliseconds available for data transfer.

The second possibility—the receiver, e.g. the photodiode or a radio receiver receives continuously—can only unfold its advantages if with strong ambient light, no significant current amount is drawn from the battery. Naturally, the transponder could continuously “receive” and thus respond immediately to each enquiry by the reading unit. The fact that this has not yet been implemented above all in optical systems is due to the following problem: the “receiving unit” of an optical transponder is a photodiode for converting light modulation into electrical current. In order to increase the limit frequency of a photodiode, a voltage is applied to the photodiode in the reverse direction. By this means, the capacitance of the photodiode and thus also the reaction time are reduced. On illumination, a current proportional to the illumination then flows, which must be drawn from the battery in order to maintain the reverse voltage.

When influenced by sunlight directly onto the photodiode, on use of a commonly available BPW 34, a few mA are needed merely to keep the photodiode continuously at the “operating point”. In this arrangement, the battery of an optical transponder would be drained too rapidly, particularly at high ambient light levels and a useful operation over a relatively long time period would therefore be precluded. If this does not take place, during illumination, the photodiode enters the saturation state, that is, even a further increase in the light output, for example, by means of a response by a reading device, generates no evaluable signal.

The charging of a capacitor with the generator voltage of the photodiode (as described above) also does not arise here, since there are no “measuring pauses”.

### BRIEF SUMMARY

The disclosure provides a device and a method wherein a transponder can react continuously—that is, not only in short time intervals pre-determined by the transponder itself—to requests from a reading unit without any significant time loss and achieving a long working life.

The transponder comprises at least one optical wake-up unit and at least one data exchange unit (transponder unit) for bidirectional data communication with at least one reading device of a, for example stationary, access control device. The transponder comprises at least one data-emitting transmitter and at least one receiver, wherein the transmitter transmits signals independently at least during some time periods. The transponder comprises at least one photodiode. The optical wake-up unit is continuously ready to receive signals for the start of the data communication by means of the data exchange unit between the transponder and the reading device. With the circuit arrangement and the aforementioned components, a transponder for a working life of, for example, more than 10 years can be operated with a commercially available button cell (3 V, 220 mA). This applies both for a radio transfer and also for an optical data transfer and even in strong extraneous light or sunlight. Continuously in the context of this application means that the transponder is ready to receive at any time and there is no time interval, e.g. following an activation time window of the transponder during which no receiving is possible. Nevertheless, in principle, the readiness to receive can be suspended as soon as the bidirectional data communication has taken place.

The wake-up unit comprises at least one optical wake-up unit and/or preferarbly at least one radio wake-up unit in order, through a combination of additional safety criteria, e.g. during the parking of vehicles, to work in an unsafe environment.

The data exchange unit can advantageously be configured as at least one optical data exchange unit or as at least one radio data exchange unit in order to fulfil the requirements of the respective technical environment.

In a preferred exemplary embodiment, the transponder has at least one current sense amplifier circuit which preferably comprises self-regulating non-linear individual stages. With this circuit a continuous reception readiness of the transponder can be ensured with little current, so that it can be operated for a long time with only a solar cell or a small battery.

It is also advantageous to operate the transponder with at least one current-saving circuit. In a particularly preferred exemplary embodiment, a photocurrent compensation is provided by limiting the photodiode generator voltage between zero and saturation by damping with a frequency-dependent resistor. This combination still further reduces the current required.

The current-saving circuit can also particularly preferably be configured as a photocurrent compensation by means of compensation with the current from a number of further electrically oppositely poled photodiodes by means of a frequency-dependent resistor. Thus, with a few inexpensive components, a highly current-saving configuration can be achieved.

The transponder is preferably to be operated with a battery, preferably a button cell, for several years, despite the continuous signal reception readiness. Alternatively, a solar cell can advantageously also be used. With a lower current requirement, both alternatives are favourably usable alone or in combination.

Preferably, the transponder is to be rapidly woken up after receipt of a first signal. This takes place in a preferred exemplary embodiment in a time from the receipt of a signal of the wake-up unit to the start of the directional data communication of the data exchange unit between the transponder and the reading device of less than one microsecond, preferably less than 200 nanoseconds.

A means is provided of an arrangement for bidirectional communication between a transponder, the advantages of which have already been described, and a reading device which transmits signals at the start of the data communication to a continuously receptive wake-up unit of the transponder to wake up a data exchange unit of the transponder. The interplay between the reading device and the transponder is matched one to the other and allows an energy-saving operation.

A means is provided of a method for bidirectional data communication of a transponder with at least one reading device, the transponder having at least one transmitter emitting data and at least one receiver. A signal which is recognized by the transponder is emitted from the reading device to the transponder. Following recognition of the signal, a bidirectional communication starts, by means of at least one data exchange unit of the transponder comprising a transmitter and a receiver, with the reading device, wherein the transmitter independently emits signals at least during some time periods. For this purpose, following recognition of the signal, the data exchange unit is woken up at the start of the bidirectional communication by means of a continuously reception-ready optical wake-up unit of the transponder, wherein the transponder is operated by at least one photodiode. By this means, a data communication can be operated in an energy-saving manner, wherein the advantages described above in relation to the device come into effect.

For further energy-saving, in a preferred exemplary emboidment, the current sense of the signal received by the transponder is amplified in the transponder.

If, in a further exemplary embodiment of the invention, a photocurrent compensation is advantageously used as a current saving circuit which limits a photodiode generator voltage between zero and saturation by damping with a frequency-dependent resistor, the current requirement can be further reduced and thereby a data communication can be established that is comfortable for the user because it requires no maintenance.

Preferably, the photocurrent compensation compensates the current from a number of further electrically oppositely poled photodiodes by means of a frequency-dependent resistor, so that with inexpensive components, the energy usage can be reduced.

Additionally, the wake-up unit can preferably be operated with a solar cell and/or a battery, preferably a button cell, for several years despite the continuous signal reception readiness, which further increases the maintenance-freedom of the transponder.

Nevertheless, the data communication is preferably very rapidly available following the waking up. Thus, the bidirectional data communication begins in a time from the receipt of a signal of the wake-up unit to the start of the data communication of less than one microsecond, preferably less than 200 nanoseconds.

In order to ensure all of this, not only are the receivers such as the photodiode kept almost current-free at the operating point, but further measures can also be implemented in the amplifier circuits in order to arrive at such a low current consumption as an operation of more than 10 years makes necessary.

Further advantages are disclosed in the subclaims and the following description of preferred exemplary embodiments.

### BRIEF DESCRIPTION OF THE FIGURES

The invention will now be described in greater detail referring to exemplary embodiments illustrated in the accompanying Figures, in which:

FIG. 1 shows a circuit arrangement with a photodiode 1.1 as a damped generator,

FIG. 2 shows a circuit arrangement for a current sense amplifier,

FIG. 3 shows a block circuit diagram for an optical transponder,

FIG. 4 shows a schematic representation of a transponder and a reading device with a transmitter and a receiver,

FIGS. 4a-4c show a representation of the data transfer for establishing a bidirectional transponder operation,

FIG. 5 shows a circuit arrangement in the case of an existing energy source in the form of photodiodes,

FIG. 6 shows time and voltage patterns at the components of the circuit arrangements.

### DESCRIPTION OF PREFERRED EXEMPLARY EMBODIMENTS

The invention will now be described in greater detail making reference to the accompanying drawings. The exemplary embodiments merely represent examples, however, which are not intended to restrict the inventive concept to a particular arrangement.

Before the invention is described in detail, it should be noted that the invention is not restricted to the various components of the device and the various method steps, since these components and method can vary. The expressions used here are intended merely to describe particular embodiments and are not used restrictively. Furthermore, where the singular or the indefinite article is used in the description or the claims, this also relates to a plurality of these elements, provided the overall context does not clearly reveal otherwise.

In describing the invention, the following consideration is assumed: in order to keep a photodiode continuously in the blocked state under illumination and thereby to obtain rapid reaction times, either an energy source is needed or rapid reaction times are dispensed with. The latter applies also to a radio receiver.

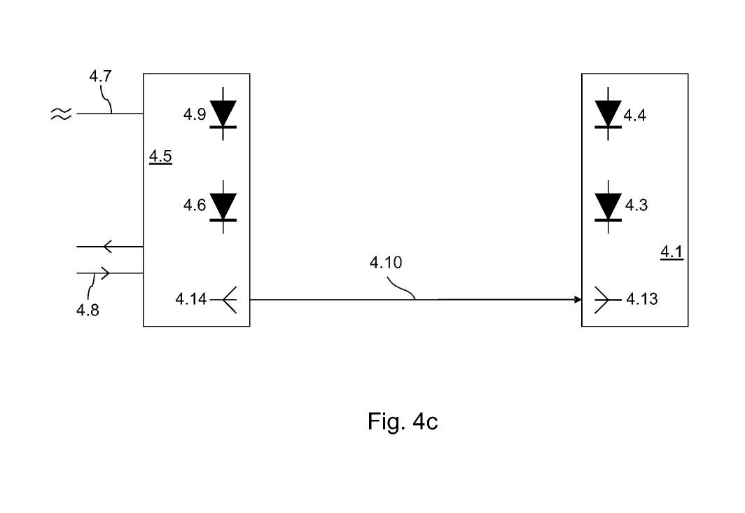

FIG. 5 shows the circuit arrangement in the event of an existing energy source in the form of photodiodes 5.1 or solar cells. The alternative solutions with a radio transmission or with coupled optical and radio transfer will be considered below.

If the energy is not to be drawn from the battery, one or more photodiodes 5.1 or solar cells can be mounted close to the photodiode 1.1, which supply the relevant power output as a generator to compensate for the photocurrent. A number of photodiodes 5.1 or corresponding solar cells produces, for example, under light irradiation, a voltage 5.8 of 2.4 V. The photodiode 1.1 is connected to this voltage 5.8 in the reverse direction via a gyrator 5.2. Assuming that there is a voltage drop of 0.8 V across the gyrator 5.2, then 1.6 V still remains as the reverse voltage at the photodiode 1.1. This is entirely sufficient to achieve a bandwidth of more than 15 MHz. The signal voltage of the photodiode is then tapped off at 1.11 and the coupling capacitor 1.3 serves only for DC decoupling.

The stronger the ambient light and thus also the photocurrent through 1.1 become, the greater the current provided by the photodiodes 5.1 also becomes. In the event of complete darkness—when the photodiodes 5.1 or the solar cells generate no voltage, no photocurrent flows through the photodiode 1.1. In order nevertheless to maintain the reverse voltage, a high resistance resistor 5.4 is connected from the supply voltage 5.7 to the cathode of the photodiode. High resistance means between a few hundred kilohms to tens of Megohms. In an ideal case, virtually no current flows via this resistor 5.4.

When light falls on the photodiodes or solar cells 5.1, the voltage 5.8 generated can also be used to charge an energy store 5.6. A reverse diode 5.3 prevents the current reverse flow with non-illuminated photodiodes 5.1 or solar cells. The energy store 5.6 can be an accumulator, if the transponder is to be operated for a relatively long time without any energy input by the photodiodes 5.1, or a relatively small capacitor if, for example, the reading device feeds the transponder directly with the energy needed for the data transfer by means of a light source.

This circuit arrangement is useful everywhere, where sufficient area is available in the transponder for photodiodes 5.1 or photocells or where the costs of these additional components is not crucial.

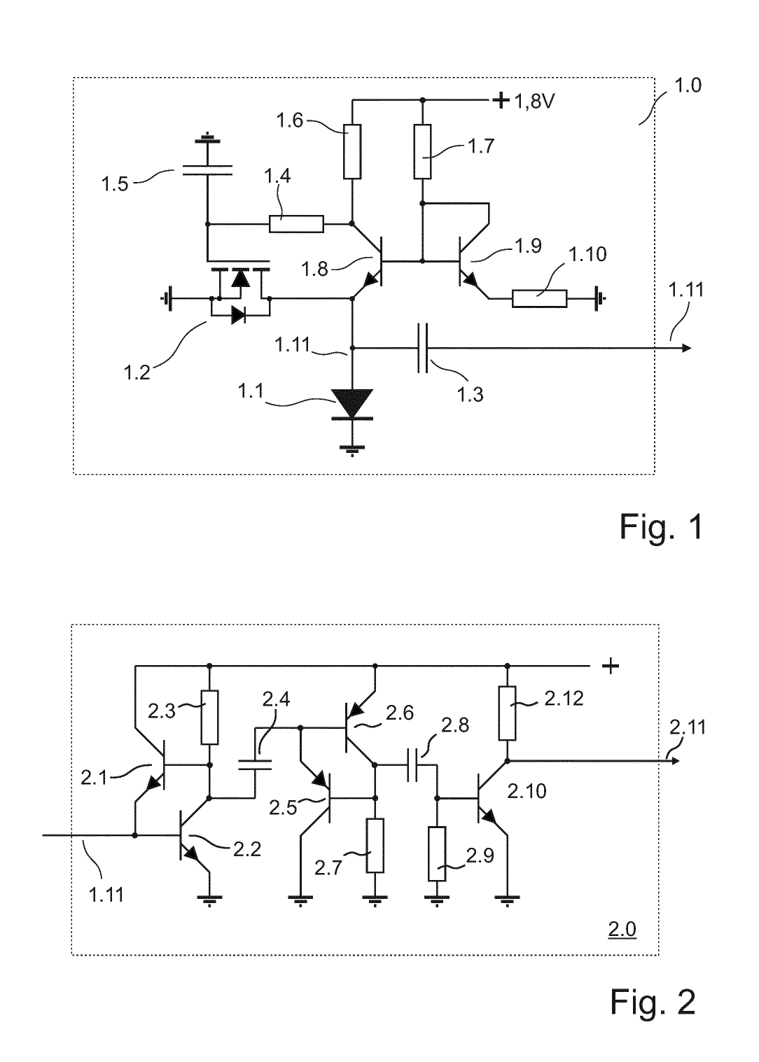

However, there are also transponder applications in which there is insufficient space, for example, if photodiodes and transmitting LEDs must also be integrated in an ASIC. In this case, according to FIG. 1, the photodiode 1.1 is operated as a damped generator. Without damping, during light influx, the voltage at the photodiode 1.1 would achieve saturation, i.e. there would be 0.4 V present at the anode. If, however, in generator operation, the voltage across a frequency-dependent resistor is held at a value of between 0 and less than 0.4 V, on a change of illumination in the case illustrated, therefore, a signal 1.11 coming from the optical signal 4.11 can be drawn off at the anode. In FIG. 1, a transistor 1.8 serves as the threshold regulator, if the direct voltage at the photodiode 1.1 exceeds a pre-determined value. The size of the threshold value is fixed with the voltage divider (resistor 1.7), the transistor 1.9 and the resistor 1.10. The transistor 1.9 serves merely as temperature compensation for the transistor 1.8. The values of the resistors 1.7 and 1.10 can be dimensioned so that a voltage of approximately 0.2 V exists at the resistor 1.10. If the voltage at the emitter of the transistor 1.8 exceeds the voltage due to the light influx to the photodiode 1.1, then the voltage at the collector of the transistor 1.8 rises. Above a particular voltage, the field effect transistor 1.2 to be regarded as a regulable resistor opens and draws from the photodiode 1.1 sufficient current, until the same voltage exists again at the resistor 1.10. Due to the resistor 1.4 and the capacitor 1.5, this control loop shows a low-pass behaviour, so that low-frequency alternating components are adjusted out and higher-frequency alternating components 1.11 can be fed via the coupling capacitor 1.3 to the subsequent amplifier stages.

Advantageously, in this circuit variant, high value resistors can be used. Thus, the value of the resistors 1.6 and 1.7 is 22 MOhm each. The value of the resistor 1.10 is calculated at a pre-determined supply voltage of e.g. 1.8 V from the voltage divider ratio of the resistor 1.7, the voltage drop at the transistor 1.9 (ca 0.5 V) and the voltage drop at the resistor 1.10. Assuming the resistor 1.10 is 4.7 MOhm, then a voltage of approximately 0.23 V exists across this resistor. Further assuming that the field effect transistor 1.2 opens at a gate voltage of 0.8 V, then a voltage drop of 1 V occurs at the resistor 1.6. Thus, there results a current of 45 nA through the resistor 1.6 and 49 nA through the resistor 1.7, together therefore approximately 94 nA for the photocurrent regulator 1.0.

The value of the resistor 1.4 can also be in the Megohm range and it serves with the capacitor 1.5 (1 nF) merely as a low pass for the gate control voltage of the transistor 1.2.

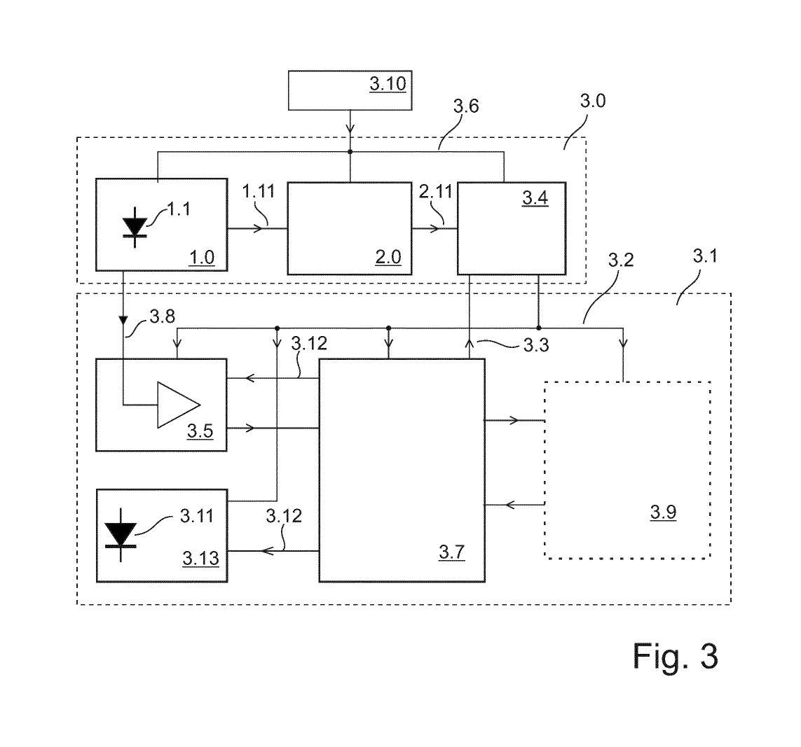

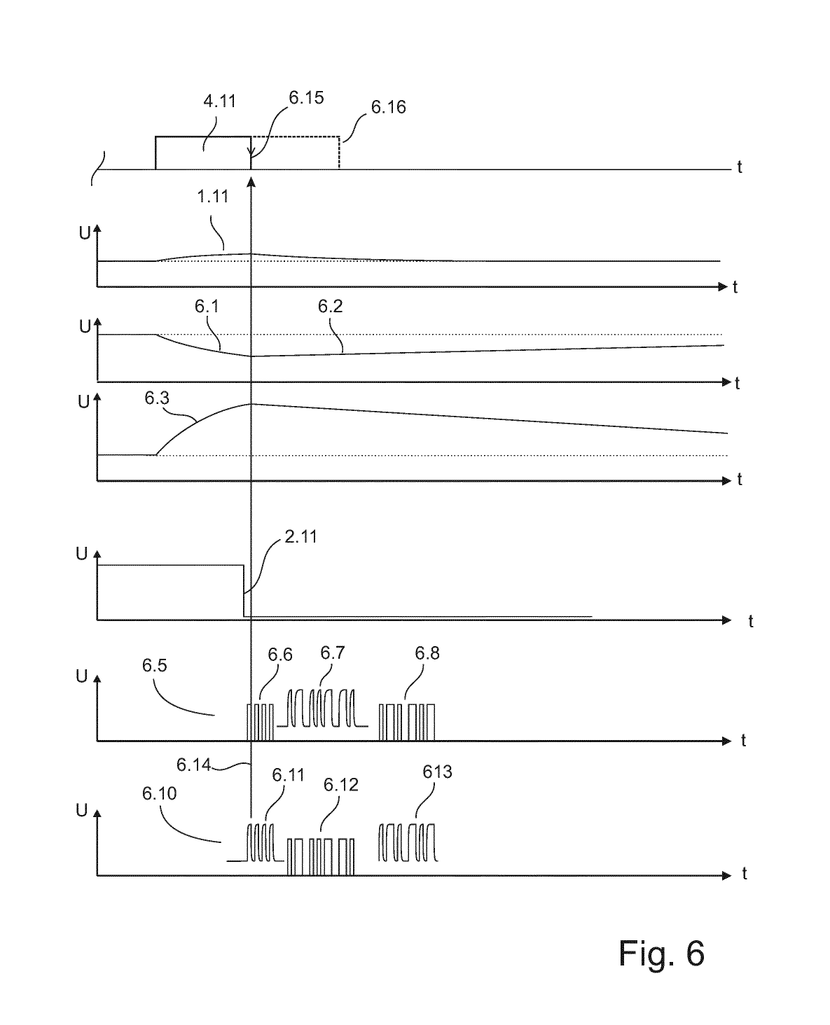

For the amplifier 2.0 (FIG. 2), self-regulating deliberately non-linear individual stages are selected. This involves current sense amplifiers. This means that a rapid current amplification takes place substantially in only one sense. The transistors 2.2, 2.1 and the resistor 2.3 form a first stage. In the circuit shown here, the collector voltage is regulated by the transistor 2.2 to a voltage that is twice the base-emitter voltage of an individual transistor, that is 2×0.5 V=approximately 1 V. It is similarly assumed that the resistor 2.3 has a relatively high value, for example 22 MOhm. Therefore, the base current of the transistor 2.2 or the emitter current of the transistor 2.1 is very small. At this small emitter current in the transistor 2.1, in the first place, however, the base-emitter capacitance of the transistor 2.1 as a frequency-determining negative feedback for the actual amplifier transistor 2.2 predominates only for as long as the transistor 2.1 is in a weakly conductive state. A positive current pulse at the base of the transistor 2.2, as is generated by the signal voltage 1.11 of the photodiode under the influence of the optical signal 4.11, causes the voltage at the collector to fall correspondingly rapidly (6.1 in FIG. 6), so that the negative feedback capacitance through the base-emitter path of the transistor 2.1 is reduced and the limit frequency for the positive current pulse is increased. Expressed simply, the voltage change 6.1 at the collector of the transistor 2.2 accelerates itself.

Since no current counteracts the base current, given a positive current surge, the full amplification factor is reached with simultaneously reduced capacitive negative feedback. In the presence of a negative current surge, the voltage at the collector of the transistor 2.2 would rise. However, this can only take place slowly (6.2 in FIG. 6) due to the restricted current flow through the high value resistor 2.3 and the capacitors connected to the collector, as well as the intrinsic collector capacitance. A negative current surge which is accompanied by a voltage fall at the base of the transistor 2.2 is stabilised via the transistor 2.1 “through a low resistance” or the capacitor 1.3 is correspondingly recharged to the opposite sign. The voltage at the collector of the transistor 2.2 consequently rises only insignificantly.

The transistors 2.5, 2.6 and the resistor 2.7 are constructed identically to the first amplifier stage, but with P rather than N transistors, since here a negative signal is to be amplified. The output signal of this second amplifier stage is shown as the line 6.3 in FIG. 6. Otherwise, the advantages—negative feedback dependent on the signal size—are the same. The capacitors 2.4 and 2.8 serve only for DC decoupling and have values of e.g. 100 pF.

Given a supply voltage of 1.8 V, there is 0.8 V on each of the resistors 2.3 and 2.7. This corresponds to a current of 36.3 nA each, that is, altogether 72.6 nA for these amplifier stages. An appreciable direct current in the switching transistor 2.10 does not arise, since it is briefly connected through and emits the output signal 2.11 only when a signal is recognised, represented by the falling edge 2.11 in FIG. 6.

Calculated together, for the photocurrent compensation 1.0 and the amplifier 2.0, there results a total current of 94 nA plus 72.6 nA, that is, altogether 166 nA. Practice has shown that even at temperatures up to over 85° C., the current remains below 180 nA in any event.

Due to the simple circuit design, latch-up effects are also precluded.

The current sense amplifier 2.0 described here reacts to an optical input pulse of a few p-seconds length or a radio pulse within 100 nanoseconds and is therefore suitable as a wake-up unit 3.0 or circuit for waking up the actual transponder function with an extremely low intrinsic current consumption at full photocurrent compensation of up to over 100 klux. In practice, therefore, ranges of over 10 metres can be achieved without difficulty. Naturally, with a desired higher sensitivity, a plurality of amplifier stages can be connected behind one another.

FIG. 6 shows the further signal sequence. The representation in the region 6.5 shows the transponder signals and the representation in the region 6.10 shows the signals of the reading device. For the sake of greater clarity, the transmitted signals 6.6, 6.8 and 6.12 are represented as “sharp edged” and the respective received signals 6.7 and 6.11 and 6.13 are shown raised and “rounded”.

If the transponder is activated by the falling edge, it initially transmits an identification 6.6 of e.g. 4 bits. Each bit then has, for example, a length of 30 nanoseconds. This short bit pattern 6.6 is received (6.11) by the reading device and tells the reading device that now a transponder has recognised its signal 4.11. If necessary, the reading device can now stop the emission of the signal 4.11, signified by the indication line 6.14 at the falling edge 6.15. Thus, only the transponder closest to the reading device is recognised. If a plurality of transponders are to be recognised simultaneously, the optical signal does not need to be stopped and it is then emitted with the full length 6.16 of e.g. 30 μs. Thus, more remote transponders are also addressed. In the desired case that a plurality of transponders are detected simultaneously, the transponders can be configured (by software) so that they do not emit their identification 6.6 immediately after recognising the optical signal 4.11, but randomly controlled at a delayed time point in order to prevent collisions.

Assuming that a small button cell rated at 220 mA/h as is normal nowadays for active transponder applications is used, then utilising the technology described here, there results purely computationally a lifespan of the battery of 125 years. If the average data traffic to be expected is taken to 1 per second with a length of 100 μs, which is already a very high estimate and with an average current consumption then arising of 1 μA for the data exchange, the calculated battery lifespan is still more than 20 years.

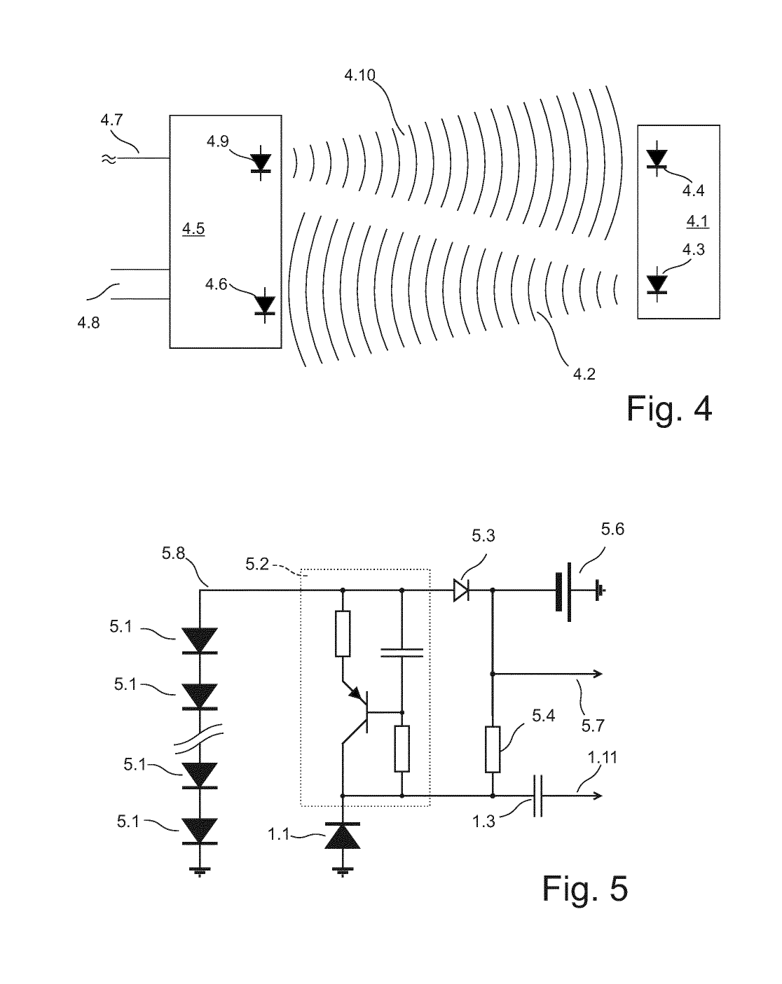

FIG. 3 shows a block circuit diagram for a preferably optical transponder. 3.10 is the energy supply. This can be a battery, an accumulator, a capacitor, a solar cell or a combination of these elements. 3.1 is the transponder unit which is also responsible for the actual data exchange and can therefore also be addressed as the data exchange unit. In principle, the transponder unit can also function with only radio, i.e. the photodiode is then a radio receiver, the transmitter is a radio transmitter and the reading device transmits a radio signal.

In principle, the wake-up unit 3.0 and the data exchange unit 3.1 do not have to be formed entirely separated. It is possible, for example, that a part of the wake-up unit is also part of the data exchange unit. Thus, the receiver 4.4 of the transponder 4.1 can be, for example, the receiver both for the signal 4.11 for waking up, as well as the receiver for the bidirectional data communication.

1.1 is the photodiode described above with photocurrent compensation 1.0 for detection of the optical signal 4.11. The signal voltage 1.11 of the photodiode 1.1 is fed to the current sense amplifier 2.0. The output signal 2.11 of the switching transistor 2.10 is fed to a flip flop 3.4. Once a signal 4.11 has been recognised, the flip flop 3.4 switches the unswitched supply voltage 3.6 from the energy supply 3.10 to the supply line 3.2 for the bidirectional transponder operation. This line supplies the preamplifier 3.5 for the data reception, the transmitting unit, the data evaluation and the control unit 3.7 and the optional data store 3.9 (shown dashed). This data store can be used for relatively large data volumes such as occur on storage of biometric data. In the exemplary embodiment, the data evaluation and the control unit 3.7 is formed by an FPGA. By means of the control lines 3.12, the preamplifier 3.5 and/or the LED driver 3.13 for the data emission at the respectively correct time point are switched to active.

The bidirectional optical transponder operation has previously been described in detail in the patent EP 2 332 269 B1, so that the function thereof need not be considered here. However, by reference to that patent, its content is hereby expressly included within the subject matter of the present application.

Following a bidirectional data transfer, the control unit 3.7 resets the flip flop 3.4 via the reset line 3.3, so that the transponder unit 3.1 is voltage free again as a data exchange unit. In the exemplary embodiment, no separate photodiode is associated with the preamplifier 3.5 for receiving rapid data signals, since for this purpose the data signal can also be taken from the photodiode 1.1, represented by the signal line 3.8.

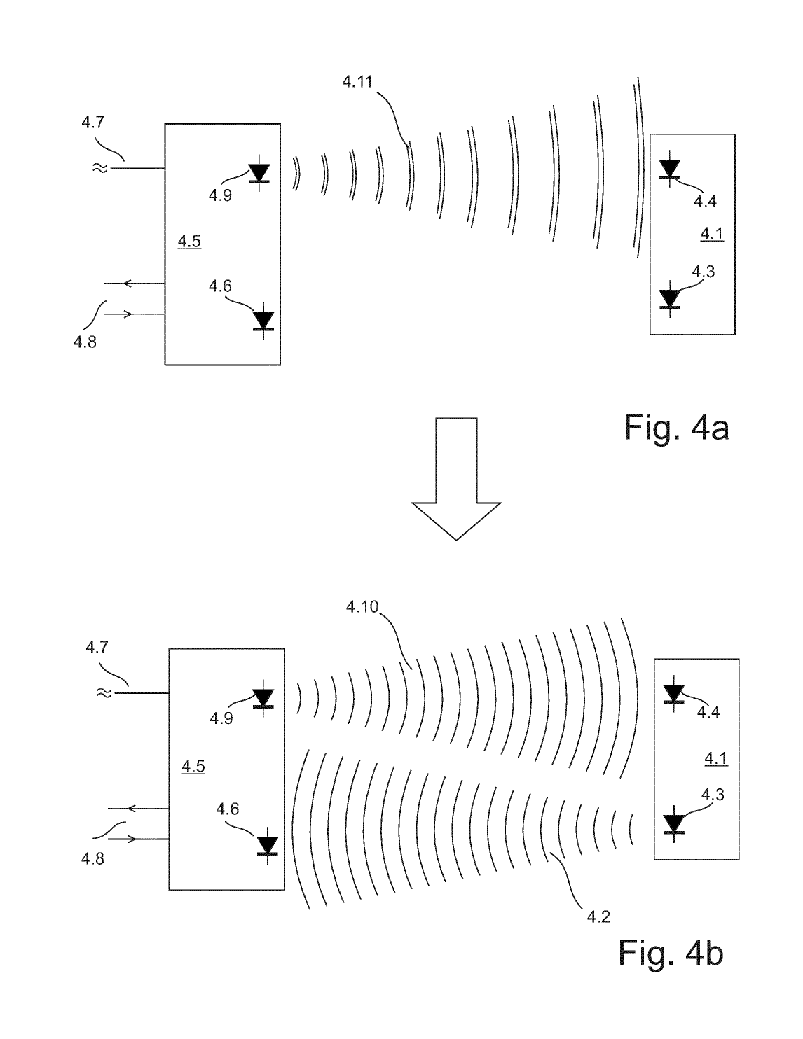

Alternatively or additionally, in place of the signal 4.11 shown in FIG. 4a, a radio signal 4.12, represented in FIG. 4c, can also be used in order to begin the bidirectional data transfer. Equally, the entire bidirectional data transfer can also take place by means of radio. For this purpose, in place of the signal voltage 1.11 of the photodiode 1.1, a corresponding output voltage of a radio receiver 4.13, shown in FIG. 4c, for receiving the radio signal 4.12 can be fed to the current sense amplifier 2.0, shown in FIG. 3, and/or depending on the signal strength, directly to the flip flop 3.4 for driving.

FIG. 4c shows an alternative embodiment of the reading device 4.5 and of the optical transponder 4.1 or quite generally, a transponder, e.g. for radio signals. In addition the transponder 4.1 comprises the radio receiver 4.13 and the reading device 4.5 comprises in addition a radio transmitter 4.14. By means of the radio transmitter, similarly to the previously described signal 4.11, the radio signal 4.12 is emitted. This can take place with a limited range in order possibly thereby to minimize associated undesirable effects. In particular, the range can be adapted to a range of the bidirectional data transfer. The radio signal 4.12 can be received by means of the radio receiver 4.13 and used to start the optical bidirectional data transfer or a radio transfer, alternatively also for switching the transponder 4.1 over again into an energy-saving stand-by state, in particular by switching off the supply voltage. As soon as the transponder 4.1 approaches the reading device 4.5, the transponder can be placed by the radio signal 4.12 into a stand-by state as described above. Optionally, the radio signal 4.12 can also be emitted in a clocked manner, in particular to save energy and/or to reduce radio communications.

According to a further alternative, by means of the radio signal 4.12, energy can be transferred to the transponder 4.1 from the reading device 4.5 connected, in particular, to the mains power supply 4.7. This energy can be used by the transponder 4.1 for the continuous data transfer and/or stored for a later stand-by phase. The energy transfer can take place, in particular, before the start of the data transfer in order to supply it immediately with the necessary energy. Alternatively or additionally, it is conceivable to sustain the energy supply during the data transfer via the radio signal 4.12. By means of the additional possibility of waking up the transponder by means of the radio signal 4.12, the reliability of the data transfer can be increased. For this purpose, in particular optionally, one of the two wake-up possibilities can be deactivated. In particular, it is possible that a communication only comes about, if both a communication via a radio link, in this case for example, for waking up by means of the radio signal 4.12, and the actual data communication take place via an optical link. It can further be provided that to start the bidirectional communication, both an optical signal 4.11 and also a radio signal 4.12 are required.

It goes without saying that this description may be subject to the broadest possible variety of modifications, changes and adaptations which are within the range of equivalents to the attached claims.

1.-19. (canceled)

20. Transponder comprising at least one wake-up unit and at least one data exchange unit for bidirectional data communication with at least one reading device,
wherein the transponder comprises at least one data-emitting transmitter and at least one receiver, wherein the transmitter transmits signals automatically at least during some time periods,
wherein the transponder comprises at least one photodiode, and
wherein the at least one wake-up unit is an optical wake-up unit, which is continuously ready to receive signals for the start of the data communication by means of the data exchange unit between the transponder and the reading device.

21. Transponder according to claim 20, wherein the transponder is configured and adapted to at least one of acquiring or controlling an access authorisation to spaces or objects.

22. Transponder according to claim 20, wherein the data exchange unit comprises at least one optical data exchange unit.

23. Transponder according to claim 20, wherein the data exchange unit comprises at least one radio data exchange unit.

24. Transponder according to claim 20, wherein the transponder comprises at least one current sense amplifier circuit.

25. Transponder according to claim 24, wherein the at least one current sense amplifier circuit comprises self-regulating non-linear individual stages.

26. Transponder according to claim 20, wherein the transponder comprises at least one current-saving circuit.

27. Transponder according to claim 26, wherein the current-saving circuit has a photocurrent compensation by limiting the photodiode generator voltage of the at least one photodiode between zero and saturation by damping with a frequency-dependent resistor.

28. Transponder according to claim 26, wherein the current-saving circuit has a photocurrent compensation by means of compensation with a current from a number of further electrically oppositely poled photodiodes by means of a frequency-dependent resistor.

29. Transponder according to claim 26, wherein the current-saving circuit is configured and adapted to operate the wake-up unit with a battery for several years despite the continuous signal reception readiness.

30. Transponder according to claim 20, wherein the transponder is suppliable with energy from at least one solar cell.

31. Transponder according to claim 24, wherein the time from a receipt of a signal of the wake-up unit until the start of the directional data communication of the data exchange unit between the transponder and the reading device with the aid of the current sense amplifier circuit is less than one microsecond.

32. Transponder according to claim 31, wherein the time from the receipt of the signal of the wake-up unit until the start of the directional data communication of the data exchange unit is less than 200 nanoseconds.

33. Arrangement for bidirectional communication between a transponder according to claim 20, and at least one reading device which transmits signals for the start of the data communication to a continuously receptive optical wake-up unit of the transponder to wake up a data exchange unit of the transponder.

34. Method for bidirectional data communication of a transponder with at least one reading device, wherein the transponder comprises at least one data-emitting transmitter and at least one receiver, comprising the steps
sending a signal from the reading device to the transponder,
recognising the signal by the transponder,
starting of a bidirectional communication by means of at least one data exchange unit with a transmitter and a receiver of the transponder, wherein the transmitter automatically emits signals at least during some time periods,
wherein by a waking up of the data exchange unit for the start of the bidirectional communication following recognition of the signal by means of a continuously reception-ready optical wake-up unit of the transponder, wherein the transponder is operated by at least one photodiode.

35. Method according to claim 34, wherein the current of the signal received by the transponder is amplified in the transponder essentially only in one current sense direction.

36. Method according to claim 34, wherein as a current-saving circuit, a photocurrent compensation limits a photodiode generator voltage between zero and saturation by damping with a frequency-dependent resistor.

37. Method according to claim 36, wherein the photocurrent compensation compensates for a current with a current from a number of further electrically oppositely poled photodiodes by means of a frequency-dependent resistor.

38. Method according to claim 36, wherein by means of the current-saving circuit the optical wake-up unit is operated with a battery for several years despite the continuous signal reception readiness.

39. Method according to claim 34, wherein the transponder is supplied with energy from at least one solar cell.

40. Method according to claim 34, wherein the bidirectional data communication is started with the aid of a current sense amplifier circuit in a time from a receipt of a signal of the wake-up unit of less than one microsecond.

41. Method according to claim 40, wherein the bidirectional data communication is started in a time from the receipt of a signal of the wake-up unit of less than 200 nanoseconds.
